(19) United States
(12) Patent Application Publication
(10) Pub. No.: US 2009/0320004 A1
(43) Pub. Date: Dec. 24, 2009

(54) Test Instrument Graphical User Interface

(76) Inventor: Kirk Fertitta, San Diego, CA (US)

Correspondence Address: LAW OFFICE OF MARK WISNOSKY, 3200 Fourth Avenue, Suite 201, SAN DIEGO, CA, 92103, US

(21) Appl. No.: 12/261,272

(22) Filed: Oct. 30, 2008

Related U.S. Application Data
(60) Provisional application No. 60/985,064, filed on Nov. 2, 2007.

(51) Int. Cl. G06F 9/45

(52) U.S. Cl. 717/148

(57) ABSTRACT

A flexible user interface that takes advantage of the data binding architecture both at compilation and post compilation is described. The architecture provides maximum flexibility to the end user for customization of instrument user interfaces while affording the manufacturer basic control on look and feel to ensure functionality and important aspects of brand appearance.

### CROSS-REFERENCE TO RELATED APPLICATIONS

This application claims the benefit of U.S. Provisional Patent Applications 60/985,064 filed Nov. 2, 2007, entitled “Test Instrument Graphical User Interface”, currently pending, by the same inventor and incorporated by reference.

### TECHNICAL FIELD

Embodiments of the invention relate to a graphical user interface for test equipment.

### BACKGROUND OF THE INVENTION

Test and measurement equipment used in the design and testing of electrical and other equipment has traditionally consisted of a mechanical user interface as well as the ability to use software control through a computer interface. The traditional mechanical user interface consists of the buttons, knobs and switches along with the output displays of numeric and graphical information. The computer control provides the ability to customize test procedures on a single instrument and provides the ability to control multiple instruments in a more complicated test regime. Instruments that are used in a manufacturing environment often require computer control to ensure consistent testing of production output as well as providing centralized reporting for quality control purposes.

The test equipment could however still be controlled manually using a front panel of switches, dials and buttons with indicators of test conditions such as oscilloscope type displays, lights, buzzers and alarms. The layout of the instrument front panel is not only functional but also helps define a look and feel that is characteristic of the manufacturer of the instrument. Manufacturers use a color scheme, a physical set of knobs, buttons, switches and displays that improve the customer experience of using the instrument. Switches may have a certain feel to them when actuated. Knobs may offer a physical resistance to turning that customers interpret as an indicator of the quality of the instrument. The resistance may also provide the customer with the ability to more finely define parameters connected with turning of the knob. The sensitivity of the instrument's response to a knob turning or even a switch or button actuation all contribute to the ease of use of the instrument and the customer experience. These collective attributes of the instrument may also provide a brand image for the company. Experienced users recognize the manufacturer of an instrument by the look and feel of the front panel even without a company logo or other marking. Collectively this look and feel for the front panel controls and display are defined here as the “skin” of the instrument.

User interfaces based entirely on a separate connected computer and associated software have recently become more prevalent. Some newer test equipment models have completely eliminated any front panel controls. All control is through the connected computer and associated software. The computer and software generated display become the primary connection between the end-user customer and the test equipment manufacturer. The user interface display is composed of representations of buttons, knobs, switches, keyboards and other graphic items utilized for user input and additionally various display objects such as numeric readouts, graphical oscilloscope-like displays are also part of the user interface. The look and feel of the test equipment to the customer and many other reasons to buy are now mediated through the computer and user interface. The display software used by the interface computer has now become an integral component of the test equipment. The skin of the instrument is now defined in software used to control it.

Often the end user customer needs to modify or customize the presentation of controls to the instrument user. In some cases the user wants only those controls required for their specific application to be visible and operational, in other cases the manufacturer of the test equipment may want to modify a control panel display or set of control panel displays for a specific customer or for different models of similar instruments. There may also be cases where a software control suite is applicable to test equipment from different manufacturers. The test equipment manufacturer may want a uniquely branded display to encourage repeat purchase of his equipment.

Typically the user interface will be programmed on a general purpose personal computer which may uses an operating system such as Microsoft Windows®. The user interface may be just one of many windows simultaneously in use on the computer. The size of the individual windows may be individually scaled in both the vertical and horizontal directions. The particular brand of the computer hardware and components therein may not be fixed. The computer and hardware graphics may be from any number of different manufacturers and the display may also be various manufacturers or may be any of several models from a particular manufacturer. The hardware may present the output display in varying resolution. The user interface design must accommodate all of these variations and still provided a look and feel through which the customer may associate the user interface display with particular test equipment.

In some cases, specific objects within the displayed user interface should behave uniquely. The user may want the display of results in the form of a graphical oscilloscope output to be provided in the most detail. When windows are scaled, the user may not want all objects to scale the same. As the size of windows are increased, the user or manufacturer may want the output display section to grow proportionally the overall size of the interface window while the buttons and knobs grow proportionally but only up to a certain point. Designers might want non-functional aspects of the display to not grow or shrink at all with scaling of the window.

The modification and customization of the controls has required computer-programming skills. The modification may be for the introduction of a new model or brand of test instrument or the modification may be by the end-user to provide a custom test environment. Changing the graphical look and functionality of the user interface has required changes in the fundamental code of the controlling software. Often the skill sets of those defining the modification are not that of a computer programmer. With the advent of higher resolution displays and more powerful hardware the ability to present more detailed and even artistic quality displays and interfaces has grown. Finding the skill of a graphic artists combined with the skill of a programmer is rare. The graphics arts task must be separated from the programming task. Now there are even more parties involved. The end-user might have neither programming nor graphics skills but still needs the ability to customize the user interface. Additionally there may be other parties who will define how a button works. This may involve providing animation or animation parameters for a switch, knob or button that visually and tactically behaves as intended. The manufacturer of the instrument may want to place constraints on what can be modified or the extent of modification allowed to the various parties. He may require for example that displays of graphical measurement data are always shown at the highest resolution allowed by the computer hardware being used. He might also want constraints such that his corporate logo is always show regardless of other modifications to the user interface.

Many of these new interfaces will be implemented using the functionality of Microsoft's® latest Windows® operating system including Windows Presentation Foundation or WPF. The controls represented by buttons knobs, displays etc. are collected in a container typically defined as a window. The operation of the controls is defined by their content. The process of creating connection between particular controls and the data that defines their behavior is called data binding. There is considerable flexibility in what the content of a control might be. It can be as simple as a text file that when bound to the control causes the text content of the file to be displayed in the middle of the button. The content is typically much more complex as the content to be bound to a control in an instrument user interface must create a connection that not only define the look and operation of the button but it must also bind to the instrument being controlled.

There is therefore a need for a user interface software design that provides the non-programming graphics artist or instrument end-user the ability to modify graphic intensive user interfaces without the need to learn and apply the programming language on which the graphics are based. There is a need to provide a data binding environment such that a user interface may be modified by an end user yet still retains the look and feel of the test equipment that is associated with the branding elements of the original equipment manufacturer. There is a need to allow modifications of the user interface be it simply re-scaling a window or customizing for a unique test regime without resort to detailed programming and still obtaining end results that provide a consistent user interface display. There is a need for a data binding regime that provides flexible skinning of the user interface while still providing constraints to maintain some minimally desired look and functionality.

### SUMMARY OF THE INVENTION

The present invention provides unique software architecture for test equipment user interfaces (UI). The graphical user interface is parameterized in such a fashion that the non-programming user may modify and customize the user interface through submission of art in standard formats such as jpeg, mpeg wav created through drawing, image capture, sound and/or video recording. The programmer defines the functionality of the controls. The “skin” that provides the look and feel is provided separately through the submission of the graphics, video or sound content content. The content may be provided at the time of program creation, but may also be provided or changed after compilation and at run-time without the need to re-program or re-compile the program. Although the new functionality is provided by unique data binding and content models implemented under Windows® Presentation Foundation one skilled in the art will recognize applicability of the invention to other operating systems, programming and instrument environments.

Embodiments of the invention improve the visual quality of displayed user interfaces, using WPF to produce user interface with high quality visuals. With classic Win32-based UI technologies such as VB6, Windows Forms, or MFC, it is very hard to produce a visually distinctive front end with photorealistic quality. The ability to create this kind of user interface was one of the key goals of WPF. The invention makes unique use of new features in the test and measurement user interface design environment. Almost all of the aspects of WPF described in this document contribute to this capability. Since the features also offer important benefits in their own right, they are described in more detail below. But besides offering their own unique benefits, most of the WPF features described in this document contribute towards the broader goal of enabling high quality application visuals.

Another embodiment enables easy customization of visuals. Most UI technologies require code to be written in order to customize the appearance of user interface elements such as controls. If you wanted to customize a button's visuals in these technologies, you would need software developers involved. You would need to manage the awkward workflow of taking visual design artifacts (e.g. bitmaps, or Adobe Illustrator drawings) and realizing those designs in code. Embodiments of the invention offer a better solution that makes it much easier to customize an application's appearance. Embodiments make it easy to plug new visuals into an existing control. Moreover, such visual customization does not require developer intervention. Microsoft's ‘Expression Interactive Designer’ program allows visual design professionals to modify the appearance of any part of a WPF UI. (WPF does not mandate the use of Microsoft's own tools—ease of integration with 3rd party tools was a design goal. A plug-in has already been written for Adobe Illustrator that allows it to export drawings into WPF applications, for example. And there are other companies producing WPF design tools.) Enabling visual design professionals to modify the UI's appearance directly offers two benefits. First, it can reduce the amount of developer involvement required, maybe to the point of not requiring any developer time at all. Second, the designer's vision is less likely to be diluted, as so often happens when developers are tasked with translating a design into an implementation. Customization of visuals costs less and the results are typically much better with WPF.

Another embodiment of the invention enables scalability and high resolution user interface displays. User interfaces can be scaled to any size and any screen resolution. If you want to expand a UI in order to fill the space available on screen, it can easily be scaled up, and it will take advantage of the extra space to render UI features in more detail. For example, you might design a panel for an oscilloscope that will work on a screen with 800×600 resolution. But if you happened to have a machine with a 1600×1200 screen, it would be a simple matter to scale the panel's size up. Controls and text would appear more crisp, as they would have quadruple the number of pixels to work with. Traces on the scope's screen would appear with greater clarity and detail, thanks to the extra space and pixels.

Scaling is not limited to simple doubling up. Another embodiment of the invention enables to scale this example UI to any size—1024×768, 900×675, 700×525, or any other resolution would all work fine, for example. Prior art UIs created with Win32-based technologies such as Visual Basic 6, Windows Forms, or Microsoft Foundation Classes (MFC) all tend to be fixed-size: if you designed a UI for a particular set of pixel dimensions, that's how many pixels it would require in these older systems. Embodiments of the present invention enable scalability in that graphics are defined in a resolution-independent form. They do not rely on bitmap imagery. This enables visuals to remain crisp, clear, and legible even at very high resolutions.

Another embodiment of the invention enables an adaptable layout. While the ability to scale a UI to fit the available space is useful, the present invention is able to offer a little more flexibility in adapting to the available space. It offers an automatic layout system that can adjust the size and position of individual elements within a user interface to adapt to the available space. For example, consider an oscilloscope panel design. If a large screen is available, you might not want to scale up the entire user interface to fill the available space—this could result in comically large knobs and buttons. It might be more useful to let these stay at their normal size, but to make the screen area that shows traces larger. The present invention's layout facilities embodiment makes it straightforward to build a UI that automatically manages the relative sizes of various parts of the user interface.

Another embodiment of the invention improves the rendering performance of the UI system. The invention uses the highest performance part of the graphics card to do its work: it uses the 3D rendering engine. It does this even for ordinary 2D features. In fact, most of the work that 3D graphics cards do is two-dimensional, because computer screens are all two-dimensional. Prior art applications rely on the old 2D acceleration system. Graphics card vendors have found that differentiation in 2D performance is not a good way to sell more graphics cards—the highest margins are to be made in the gaming and CAD markets, both of which care about 3D performance. Consequently, graphics card vendors concentrate on 3D performance, while 2D performance has stagnated. This has limited what 2D desktop applications can achieve with their visuals. Because the present invention uses the 3D acceleration system to render all content, it can cope with much more complex visuals than prior art application without loss of performance. This makes it possible to create more subtle and detailed user interfaces, improving the visual quality of the application without sacrificing its responsiveness.

Another embodiment of the invention improves animation for the UI. Almost any aspect of a user interface can use the improved animation system. You can animate size, position, color, scale, rotation, or shape, for example. Animation can provide a user interface with a more natural feel. A switch that flips instantaneously from one position to another is somewhat unreal. But a switch control that can be seen to move between positions will look more realistic. Animation is used heavily in Windows Vista's new ‘Aero’ theme to provide visual cues. When a UI element lights up to indicate that it has the focus, or is selected, it tends to use an animated cross fade to provide a less jarring transition. The effect is subtle but pervasive. Embodiments of the invention make effective use of the se new features in the UI environment. Another embodiment of the invention manages animation automatically. No code is required. Visual designers can add animation as part of the UI customization process described earlier.

Another advantage of the invention is future support Microsoft has positioned WPF as the core user interface technology for the future. While classic Win32 applications will continue to be supported indefinitely, future innovations and improvements in Windows' UI capabilities will happen in WPF not Win32. For example, the new ‘Aero Glass’ look in Windows Vista and its new desktop composition engine are both built on top of WPF. Win32 applications will eventually go the way of 16-bit Windows applications, and DOS applications before them: they'll still run on Windows decades down the line, but they'll be a dead end. Embodiments of the present invention ensure future compatibility and support.

### BRIEF DESCRIPTION OF THE DRAWINGS

The novel features of the invention are set forth in the appended claims. The invention, as well as a preferred mode of use including further objectives and advantages will best be understood by reference to the following detailed description of an exemplary embodiment read in conjunction with the accompanying drawings.

FIG. 1 is a block diagram showing a computing environment in which aspects of the invention may be implemented.

FIG. 2 is a diagram of the computer and test instrument environment in which aspects of the invention may be implemented.

FIG. 3 is a computer generated front panel display in a window in accordance with one embodiment of the invention.

FIG. 4 is a block diagram of objects in accordance with one embodiment of the invention.

### DETAILED DESCRIPTION

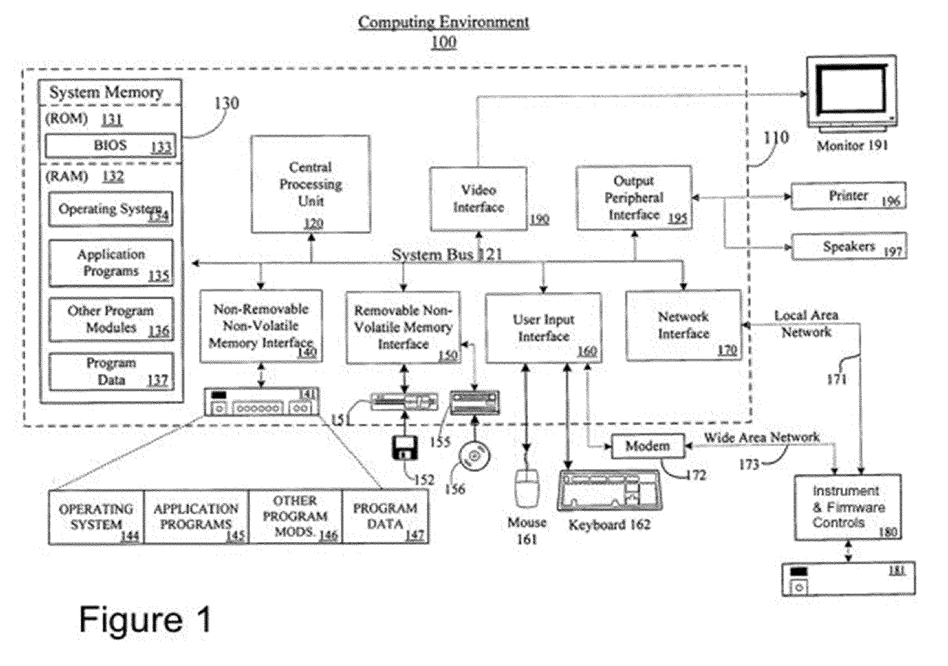

FIG. 1 depicts a suitable computing environment in which an exemplary embodiment of the invention may be implemented. Computers and computing environments refer to any machine or system that comprises a processor 120 capable of executing an operating system 133, 134 and program code 135, 136 that acts upon data 137, a display means 191 used to interact with the user, input means 161, 162 to accept instructions from the user, storage means 131, 132, 140, 150, 151, 152, 155, 156 to store the operating system. Program code and data and connection means 171, 172, 173 to interact with other devices such as an instrument 200 to be controlled as well as printers and other common peripherals 196, 197. Non-limiting and non-exclusive examples of computing environments include personal computers, workstations, mainframe computers, personal digital assistants, cell phones, and game stations. The computing environment may be locally contained or components may be distributed remote from one another and connected by means such as wired or wireless local or wide are networks or through other interface buses known to the industry.

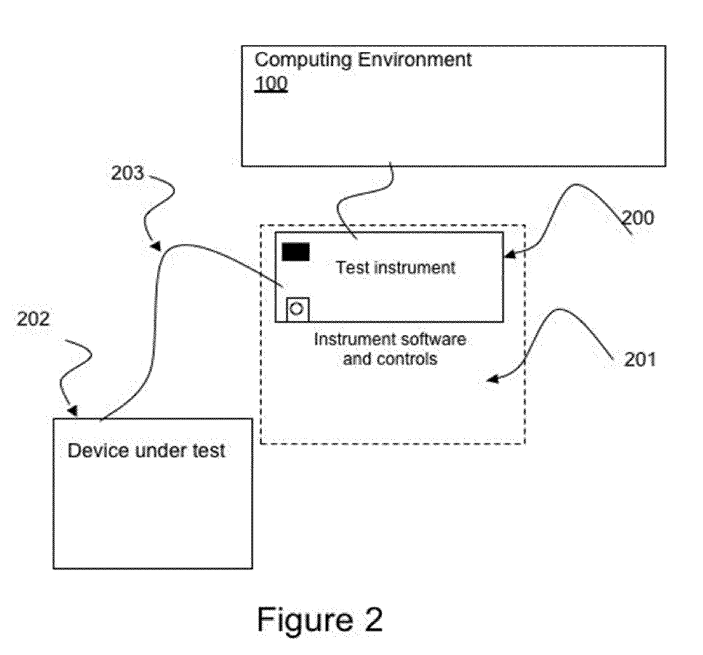

FIG. 2 depicts a testing environment in which an exemplary embodiment of the invention may be implemented. An instrument 200 which has embedded software or firmware for effecting controls 201 is connected through some connection means 203 to a device 202 that is to be tested. The test instrument 200 is connected through a connection means 204 to the computing environment 100, an example of which is depicted in FIG. 1. The connection means 204 and 203 may be various wired or wireless means already discussed as common to the industry.

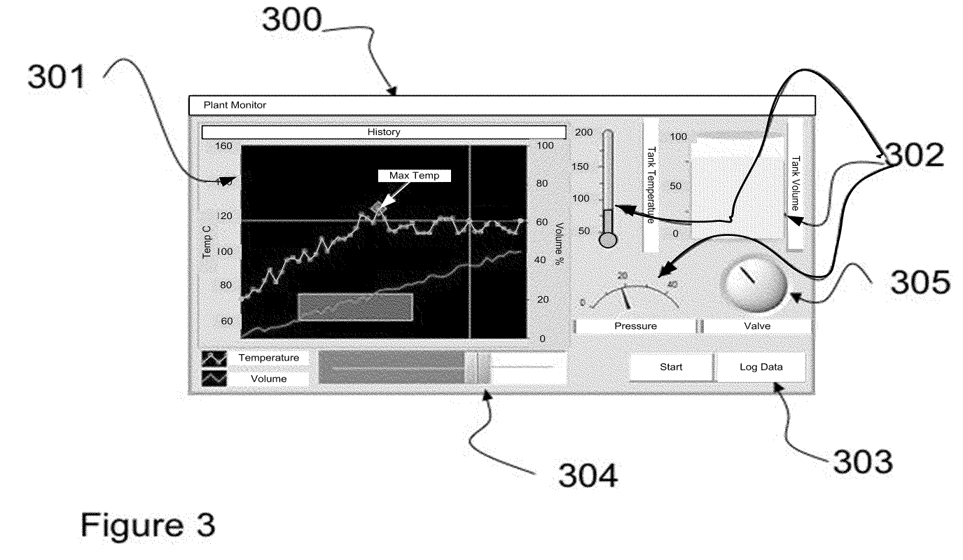

FIG. 3 depicts an exemplary user interface implementing the invention. The window 300 is a container for various graphical objects 301-305 which may be used variously for user input to control the instrument 200 and to display output from the instrument. Specific appearance and functionality is determined by the data binding to the object in question. Objects may be used for output such as an oscilloscope styled graphic display 301 and other output graphics 302. Example input objects are buttons 303, sliders 304, and knobs 305. As an example the data label 306 on button 303 is the result of data binding a text file containing characters “log data” to the content of the button graphic object 303. All aspects of the object 303 are the result of data binding of data files to its content. Data files describe the size, shape, response to user actions and functionality for each of the objects 301 to 305. Data files may contain text, graphics, etc or any .NET file. A set of the bound data files may describe the basic functionality and be programmatically fixed. A knob for input in general will not itself be bound to functional files that make it an oscilloscope like display and likewise the basic functionality of an oscilloscope like display 301 will not be mapped to functionality defining it as a knob or button. This basic functionality for the graphic objects may be defined as the core data binding set for the invention. Beyond this core data binding the process of binding the data to the objects providing look, feel, labels, operation and even visibility of the object is the “skin” for the instrument display.

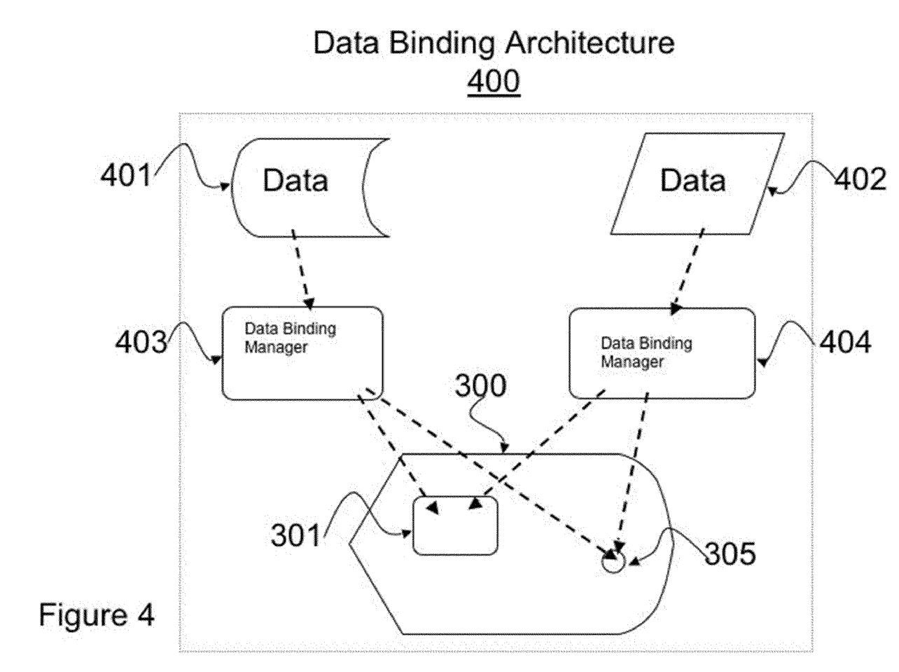

Referring now to FIG. 4, in one embodiment the core data 401 is bound through a data binding manager 403 to each object 301 and 305 in container 300. This binding of data through 403 may define the basic and default operational aspect of the user interface. In a second step a second set of data 402 is bound through a second data binding manager 404 to the same graphic objects 301 and 305. The first set of data content 401 may define that 301 is a display and 305 is a knob. The second set 402 may define the resolution, response time, background color, cursor and how the object changes with resizing of the container 300 window for the object 301 and the color, sensitivity on actuation and the parameter that is input and label for the object 305. In another embodiment, the second binding “skins” the user interface. The data binding through 403 may occur during compilation of the program. Data binding through 404 may occur at some time later. The selection of what data is contained in 401 and what is contained in 402 defines the subsequent flexibility allowed in post compilation modification of the user interface. This may be restricted to as little as the color of the background on the container to as broad as which objects are visible, their individual look and functionality.

In another embodiment the data binding through 404 occurs at appoint to customize the interface to be control a particular instrument 200. In another embodiment binding through 404 occurs after an upgrade to the firmware 201 for an instrument 200. In yet another embodiment the data binding through 404 occurs at run time by the end user customizing the user interface for a particular application.

In another embodiment of the invention a drag and drop user interface is provided that regulates the scope of the data binding through 404. If the modification to the user interface is being made by a designer for the system more extensive access is provided. If the modification to the user interface is to be limited for example at the end user or perhaps even to a selected sub-population of the end user then access control to data mapping may be limited.

Conclusions

A flexible user interface that takes advantage of the data binding architecture both at compilation and post compilation is described. The architecture provides maximum flexibility to the end user for customization of instrument user interfaces while affording the manufacturer basic control on look and feel to ensure functionality and important aspects of brand appearance.

While the invention has been shown and described with reference to a preferred embodiment, it will be understood by those skilled in the art that various changes in form and detail may be made without departing from the spirit and scope of the invention

What is claimed is:

1. A data binding architecture for an instrument user interface comprising a compilation data binding step and a post compilation data binding step, wherein the compilation data binding source and the post compilation data binding source are different and the compilation data binding step and the post compilation data binding step act upon the same objects in the same container.
